(19) United States
(12) Patent Application Publication
(10) Pub. No.: US 2006/0116501 A1
(43) Pub. Date: Jun. 1, 2006

(54) Polyisocyanates blocked with sterically hindered phenols

(75) Inventors: Michael Mager, Leverkusen (DE); Joachim Simon, Dusseldorf (DE); Frank Richter, Leverkusen (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 11/235,861

(22) Filed: Sep. 27, 2005

(30) Foreign Application Priority Data
Oct. 1, 2004 (DE) 102004047921.6

(51) Int. Cl. C08G 18/00

(52) U.S. Cl. 528/44

(57) ABSTRACT

The present invention relates to a process for preparing blocked polyisocyanates wherein at least 50 mole % of the NCO groups have been blocked with sterically hindered phenols by reacting a) one or more organic polyisocyanates with b) one or more sterically hindered phenols in the presence of c) at least one catalyst selected from i) heterocyclic amines in which at least one nitrogen atom is part of an aliphatic, olefinic or aromatic ring,
ii) tetraorganoammonium and tetraorganophosphonium salts of weak acids (pkₐ≧2.0), with nitrogen- and/or phosphorus-attached aliphatic, cycloaliphatic, araliphatic and/or aromatic radicals, and iii) zinc(II) compounds. The present invention also relates to the resulting blocked polyisocyanates and to their use for producing coatings, adhesives or sealants suitable for contact with foods and/or drinking water.

### BACKGROUND OF THE INVENTION

1. Field of the Invention

The present invention relates to polyisocyanates blocked with bulky phenols, to a process for their preparation and to their use for producing coatings, adhesives or sealants suitable for contact with foods and/or drinking water.

2. Description of Related Art

Blocked polyisocyanates are used primarily for producing polyurethane coatings. The reversible blocking of the NCO groups allows the preparation of one-component compositions containing a blocked polyisocyanate and an NCO-reactive compound, generally a polyol, which can be cured to form a polyurethane by, for example, thermal treatment. During this curing the blocking agent is released and subsequently remains to a greater or lesser extent in the coating. Blocked polyisocyanates are also of particular importance in the preparation of aqueous polyisocyanate dispersions or polyurethane dispersions and also in powder coatings. A review of the chemistry and applications of blocked polyisocyanates is found, inter alia, in Progress in Organic Coatings, 1999, 36, 148-172 and loc. cit. 2001, 41, 1-83.

Examples of typical blocking agents for polyisocyanates include phenols, alcohols, oximes, pyrazoles, amines and CH-acidic compounds such as diethyl malonate. The blocking reaction is typically carried out by reacting the free NCO groups with the blocking agents in the presence of catalysts such as dibutyltin dilaurate or tin(II) bis(2-ethylhexanoate).

For coatings which are to be used in contact with foods and/or drinking water there are generally only certain ingredients approved, and so the blocking agents commonly employed cannot be used. Because of their outstanding properties and ease of application, however, there is great interest in being able to use 1K (one-component) polyurethane coatings for the internal coating of cans.

One compound potentially suitable as a blocking agent, which is also approved for food use is 2,6-di-tert-butyl-4-methylphenol (ionol, BHT). However, it is acknowledged that sterically hindered phenols such as BHT, due to their steric hindrance, do not react sufficiently with NCO groups to achieve adequate blocking of more than 50% of the NCO groups. For this reason they have not to date been used as blocking agents. These compounds are typically used as antioxidants, and in that context are in fact used to stabilize polyisocyanates with free NCO groups.

U.S. Pat. No. 5,064,902 contains a non-specific list of polyisocyanate blocking agents which includes 2,6-di-tert-butyl-4-methylphenol, but there is no description of any method or catalyst with adequate reactivity to free NCO groups that could be used to obtain a satisfactory blocking result. To what extent BHT-blocked polyisocyanates are suitable for producing coatings or adhesive bonds approved for contact with foods and/or drinking water is not described.

It has now been found that polyisocyanates in which at least 50% the NCO groups have been blocked with bulky phenols can be prepared if specific catalysts are used for the blocking reaction. Also, the blocked polyisocyanates can be used for producing 1K polyurethane coatings that are benign for contact with foods and/or drinking water.

### SUMMARY OF THE INVENTION

The present invention relates to a process for preparing blocked polyisocyanates wherein at least 50 mole % of the NCO groups have been blocked with sterically hindered phenols by reacting
a) one or more organic polyisocyanates with
b) one or more sterically hindered phenols in the presence of
c) at least one catalyst selected from
   i) heterocyclic amines in which at least one nitrogen atom is part of an aliphatic, olefinic or aromatic ring,
   ii) tetraorganoammonium and tetraorganophosphonium salts of weak acids (pkₐ≧2.0), with nitrogen- and/or phosphorus-attached aliphatic, cycloaliphatic, araliphatic and/or aromatic radicals,
   and
   iii) zinc(II) compounds.

The present invention also relates to the resulting blocked polyisocyanates and to their use for producing coatings, adhesives or sealants suitable for contact with foods and/or drinking water.

### DETAILED DESCRIPTION OF THE INVENTION

“Sterically hindered” means for the purposes of the present invention that the phenols in positions 2 and 6 of the aromatic ring have substituents which, on the basis of their three-dimensional size, shield the OH group of the phenolic ring and result in an attenuated reactivity. Substituents of this kind are preferably organic radicals having more than 2, preferably 3 to 10, carbon atoms.

Suitable polyisocyanates of component a) include the known aliphatic, cycloaliphatic or heterocyclic organic isocyanates, preferably di- or polyisocyanates having at least two isocyanate groups, and mixtures of these compounds. Examples of suitable di- or triisocyanates include butane diisocyanate, pentane diisocyanate, hexane diisocyanate (hexamethylene diisocyanate, HDI), 4-isocyanatomethyl-1,8-octane diisocyanate (tri-isocyanatononane, TIN), 4,4′-methylenebis(cyclohexyl isocyanate) (Desmodur® W, Bayer AG, Leverkusen), 3,5,5-trimethyl-1-isocyanato-3-isocyanatomethylcycloheaxane (isophorone diisocyanate, IPDI) and ω,ω′-diisocyanato-1,3-dimethylcyclohexane (H6XDI), for example.

Also suitable for the use in invention are the known derivatives of the preceding isocyanates which have biuret, isocyanurate, iminooxadiazinedione, uretdione, allophanate and/or urethane groups.

In the process of the invention it is preferred to employ aliphatic polyisocyanates having at least two isocyanate groups. Especially preferred are hexane diisocyanate, 4,4′-methylenebis(cyclohexyl isocyanate) and isophorone diisocyanate, and also derivatives thereof having uretdione, isocyanurate, imino-oxadiazinedione, allophanate and/or biuret groups.

The bulky or sterically hindered phenols employed as component b) correspond to formula (I) 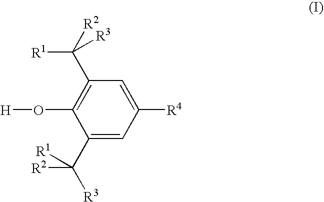
wherein
R¹, R² and R³ independently of one another are hydrogen or C₁-C₃ alkyl radicals and
R⁴ is hydrogen or a C₁-C₁₂ alkyl radical.

Preferred sterically hindered phenols of component b) correspond to formula (I)

wherein

R¹, R² and R³ independently of one another are hydrogen or a methyl radical and
R⁴ independently of R¹, R² and R³ is hydrogen or a methyl radical.

Particularly preferred sterically hindered phenols of component b) correspond to the formula (I) wherein
R¹, R² and R³ is a methyl radical and
R⁴ independently of R¹, R² and R³ is hydrogen or a methyl radical.

An especially preferred sterically hindered phenol is 2,6-di-tert-butyl-4-methylphenol (ionol, BHT).

Preferred zinc(II) compounds for use as component iii) are zinc(II) halides and zinc(II) salts of organic acids of the formula Zn(II)(COOR)₂, wherein R is an optionally branched aliphatic C₁-C₃₀ radical.

Preferred catalysts used in the process of the invention are zinc(II) salts of organic acids of the formula Zn(II)(COOR)₂ wherein R is an optionally branched aliphatic C₂-C₂₀ radical. Especially preferred are the zinc(II) salts of 2-ethylhexanoic acid or stearic acid.

Also preferred as catalysts are 1,8-diazabicyclo[5.4.0]undec-7-ene (DBU, formula II a) or 1,5-diazabicyclo[4.3.0]non-5-ene (DBN, formula II b).

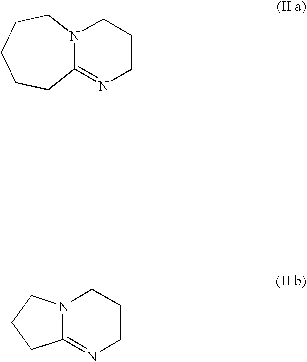

In the process of the invention components a)-c) and optionally also solvents and other additives are mixed in any desired order and heated to temperatures of 40° C. to 150° C., preferably at 60° C. to 120° C., more preferably at 60° C. to 100° C. Heating is then continued until the desired NCO content is reached.

In one preferred embodiment of the process of the invention the polyisocyanate, optionally in solution in a solvent, is initially charged to the reaction vessel and heated, optionally with stirring, to 40 to 150° C., preferably to 60 to 120° C. and more preferably to 60 to 100° C. When the desired temperature has been reached the blocking agent and the catalyst are added in any order, optionally both in solution in a solvent, and the mixture is stirred until the desired NCO content is reached. Thereafter the reaction mixture is cooled and optionally also provided with a reaction stopper, such as benzoyl chloride, to deactivate the catalyst.

In another preferred embodiment of the process of the invention the procedure described above is followed with the modification that the blocking agent is included in the initial charge and the polyisocyanate is added. The catalyst can in this case be added before, during or after the phenol has been added. All of the components, as before, can be used in solution in a suitable solvent.

The abovementioned catalysts are preferably used in amounts of 0.001% to 1% by weight, more preferably 0.01% to 1% by weight, based on the total reaction mixture.

Using the catalysts according to the invention in the abovementioned amounts ensures that at least 50 mole %, preferably at least 75 mole %, of the NCO groups of a polyisocyanate are blocked with a bulky phenol of formula (I).

Examples of suitable inert solvents or paint solvents include ethyl acetate, n-butyl acetate, methoxypropyl acetate, methyl ethyl ketone, methyl isobutyl ketone, toluene, xylene, aromatic or (cyclo)aliphatic hydrocarbon mixtures or any desired mixtures of such solvents. It is also possible, however, to carry out the reaction without solvent.

The amount of the blocking agent of formula (I) that is used is determined primarily by the desired degree of blocking of the NCO groups with the blocking agent. To achieve a degree of blocking of at least 50 mole %, the blocking agent is used in a corresponding amount of at least 50 mole %, based on all of the free NCO groups that are present. It is preferred, however, to use 50 to 150 mole %, more preferably 95 to 110 mole %, of the phenol of formula (I), based on the amount of the free NCO groups that are present.

The degree of blocking of the NCO groups of the polyisocyanate obtained by the process of the invention is at least 50 mole %, preferably at least 90 mole % and more preferably at least 95 mole %, based on the total amount of NCO groups.

The phenolically blocked polyisocyanates prepared in accordance with the invention are used typically in combination with polyols such as polyester polyols, polyether polyols or polyacrylate polyols for producing polyurethane, polyurea or polyurethane-urea coatings.

The blocked polyisocyanates prepared in accordance with the invention may optionally be dissolved in a suitable solvent, mixed with one or more polyols and subsequently subjected to thermal treatment. It is also possible to add additives such as dyes, pigments and catalysts to-these mixtures.

The resulting compositions can be applied using known techniques, such as knife coating, pouring, flow coating, spraying, rolling or brushing.

These coatings are used in particular where there is contact with foods or drinking water, especially under FDA 175.105 and 175.300. Examples are the coating of packaging materials or processing/conveying equipment for foods or drinking water. These materials or units may be composed, for example, of metals, such as iron or aluminium. The coatings are especially suited for the coating of cans by the coil-coat process.

### EXAMPLES

Unless indicated otherwise all percentages are to be understood as being percentages by weight.

The NCO contents were determined by back-titrating di-n-butylamine added in excess with 0.1 N hydrochloric acid using bromophenol blue as the indicator, the sample having been dissolved beforehand in 50 ml of acetone.

Desmodur® N 3300—trimerized 1,6-hexane diisocyanate, NCO content 21.8% by weight and viscosity 3000 mPas (23° C.) (available from Bayer MaterialScience AG, Leverkusen, DE)

Desmodur® Z 4470—trimerized isophorone diisocyanate, 70% solution in n-butyl acetate, NCO content 11.9% by weight (available from Bayer MaterialScience AG, Leverkusen, Del.).

### Comparative Example 1

33.2 g of a trimerized 1,6-hexane diisocyanate (Desmodur® N 3300) having an NCO content of 21.8% by weight and a viscosity of 3000 mPas (23° C.) were dissolved in 75 g of n-butyl acetate and the solution was heated to 80° C. with stirring. Then, in portions, 41.8 g of 2,6-di-tert-butyl-4-methylphenol were added and, finally, 20 mg of dibutyltin dilaurate were added. After. 47 hours of stirring at 80° C. the NCO content was 4.52% by weight, i.e., the catalyst employed was ineffective (calculated NCO content before adding catalyst: 4.83% by weight).

### Comparative Example 2

Following the procedure of Comparative Example 1, 33.2 g of Desmodur® N 3300 were reacted with 41.8 g of 2,6-di-tert-butyl-4-methylphenol (ionol) in n-butyl acetate and in the presence of 20 mg of tin(II) bis(2-ethylhexanoate). After 47 hours at 80° C. the NCO content was 4.44% by weight. This tin compound was also catalytically ineffective.

### Example 1

Following the procedure of Comparative Example 1, 33.2 g of Desmodur® N 3300 were reacted with 41.8 g of 2,6-di-tert-butyl-4-methylphenol (ionol) in n-butyl acetate and in the presence of 20 mg of zinc(II) bis(2-ethylhexanoate). After 47 hours at 80° C. the NCO content was 0.6% by weight.

### Example 2

Following the procedure of Comparative Example 1, 33.2 g of Desmodur® N 3300 were reacted with 41.2 g of 2,6-di-tert-butyl-4-methylphenol (ionol) in n-butyl acetate and in the presence of zinc(II) bis(2-ethylhexanoate):

The table below sets forth the amounts of the catalyst used in each case, the NCO contents achieved, the residual amounts of free 2,6-di-tert-butyl-4-methylphenol (determined by means of GC) and the reaction times.

| Amount of | | | |
|---|---|---|---|
| catalyst based on | | | |
| the reaction | Reaction | NCO content | Residual ionol content |
| mixture | time [h] | [% by weight] | [% by weight] |
| 200 ppm | 30 | 0.64 | 7.9 |
| 500 ppm | 30 | 0.55 | 7.9 |

(The calculated residual ionol content was 6.1% when the NCO contents attained were taken into account.)

### Example 3

54.6 g of Desmodur® Z 4470 were diluted with 58.6 g of n-butyl acetate with stirring and heated to 80° C. Thereafter 36.7 g of 2,6-di-tert-butyl-4-methylphenol and 0.02 g of DBN were added and heating took place to 80° C. After the reaction mixture had been stirred at 80° C. for about 24 h, a further 0.02 g of DBN was added, after which stirring again took place at 80° C. for about 48 hours and then finally the reaction mixture was left to stand at ambient temperature for about 60 h. The resulting NCO content was 0.1%.

### Example 4

Following the procedure of Example 3, 54.6 g of Desmodur® Z 4470 were reacted with 2,6-di-tert-butyl-4-methylphenol in n-butyl acetate, using 10 mg of DBU instead of 20 mg of DBN as catalyst. After a reaction time at 80° C. of approximately 40 hours, catalysis was repeated with 10 ml of DBU. After a further 8 h at 80° C. the reaction mixture was left to stand for about 60 h at ambient temperature. An NCO content of 0.1 % was attained.

In order to ensure that the sterically hindered phenol had reacted with the NCO groups, the ionol content as well as the NCO content of the product was determined by means of GC. It was found to be 3.3% by weight (initial value, calculated: 24.5% by weight).

### Example 5

23.5 g of isophorone diisocyanate were dissolved with stirring in 75.1 g of n-butyl acetate and the solution was heated to 80° C. Then, in portions, 51.3 g of 2,6-di-tert-butyl-4-methylphenol and 0.1 g of DBN were added and the reaction mixture was heated at 80° C. for about 72 hours. After the reaction mixture had been left to stand at ambient temperature for 60 h, it was no longer possible to find any free isocyanate groups by means of titration.

### Example 6

A mixture of 40 g (0.18 mol) of 2,6-di-tert-butyl-4-methylphenol and 360 g (2.14 mol) of HDI was admixed at 60° C. and with stirring with 0.26 g (0.43 mmol) of a 50% strength solution of tetrabutylphosphonium hydrogen difluoride [BU₄P]⁺ [HF₂]⁻ in isopropanol. With a considerable exotherm (the internal temperature of the reaction mixture rose to 95° C.) and a drop in the NCO content to 39.4% over the course of 5 minutes the principal product formed, alongside small amounts of HDI isocyanurates and HDI urethanes, was the allophanate of the formula (III) 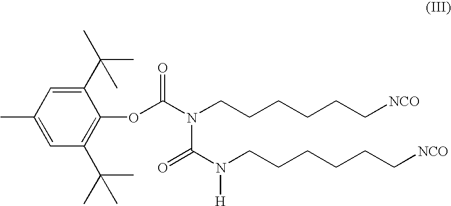
and also its higher homologs. Following the addition of 0.2 g (0.5 mmol) of a 40% strength solution of p-toluenesulphonic acid in isopropanol, for the purpose of deactivating the catalyst, and following subsequent thin-film distillation, 114.7 g of a colorless resin were obtained which had the following properties:
Viscosity: 13,600 mPas/23°
NCO content: 15.3%
Color number: 42 APHA
Residual HDI content: 0.01%
Ionol was not detectable (<10 ppm).

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A process for preparing a blocked polyisocyanate wherein at least 50 mole % of the NCO groups have been blocked with a sterically hindered phenol which comprises reacting
a) one or more organic polyisocyanates with
b) one or more sterically hindered phenols corresponding to formula (I) 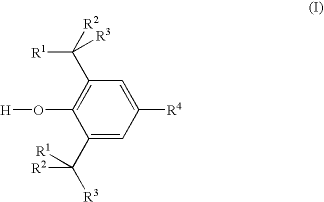
wherein
R¹, R² and R³ independently of one another are hydrogen or C₁-C₃ alkyl radicals and
R⁴ is hydrogen or a C₁-C₁₂ alkyl radical, in the presence of
c) at least one catalyst comprising a member selected from the group consisting of
i) heterocyclic amines in which at least one nitrogen atom is part of an aliphatic, olefinic or aromatic ring,
ii) tetraorganoammonium and tetraorganophosphonium salts of weak acids (pkₐ≧2.0), with nitrogen- and/or phosphorus-attached aliphatic, cycloaliphatic, araliphatic and/or aromatic radicals,
and
iii) zinc(II) compounds.

2. The process of claim 1 wherein catalyst c) comprises a member selected from the group consisting of zinc(II) salts of 2-ethylhexanoic acid, zinc(II) salts of stearic acid, 1,8-diazabicyclo[5.4.0]undec-7-ene (DBU) and 1,5-diazabicyclo[4.3.0]non-5-ene (DBN).

3. The process of claim 1 wherein the sterically hindered phenol comprises 2,6-di-tert-butyl-4-methylphenol.

4. The process of claim 2 wherein the sterically hindered phenol comprises 2,6-di-tert-butyl-4-methylphenol.

5. The process of claim 1 wherein at least 95 of the NCO groups have been blocked with a sterically hindered phenol.

6. The process of claim 2 wherein at least 95 of the NCO groups have been blocked with a sterically hindered phenol.

7. The process of claim 3 wherein at least 95 of the NCO groups have been blocked with a sterically hindered phenol.

8. The process of claim 4 wherein at least 95 of the NCO groups have been blocked with a sterically hindered phenol.

9. A blocked polyisocyanate wherein at least 50 mole % of the NCO groups have been blocked with a sterically hindered phenol which is prepared by a process comprising reacting
a) one or more organic polyisocyanates with
b) one or more sterically hindered phenols corresponding to formula (I) 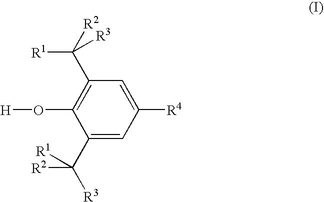
wherein
R¹, R² and R³ independently of one another are hydrogen or C₁-C₃ alkyl radicals and
R⁴ is hydrogen or a C₁-C₁₂ alkyl radical, in the presence of
c) at least one catalyst comprising a member selected from the group consisting of
i) heterocyclic amines in which at least one nitrogen atom is part of an aliphatic, olefinic or aromatic ring,
ii) tetraorganoammonium and tetraorganophosphonium salts of weak acids (pkₐ≧2.0), with nitrogen- and/or phosphorus-attached aliphatic, cycloaliphatic, araliphatic and/or aromatic radicals,
and
iii) zinc(II) compounds.

10. The blocked polyisocyanate of claim 9 wherein catalyst c) comprises a member selected from the group consisting of zinc(II) salts of 2-ethylhexanoic acid, zinc(I) salts of stearic acid, 1,8-diazabicyclo[5.4.0]undec-7-ene (DBU) and 1,5-diazabicyclo[4.3.0]non-5-ene (DBN).

11. The blocked polyisocyanate of claim 9 wherein the sterically hindered phenol comprises 2,6-di-tert-butyl-4-methylphenol.

12. The blocked polyisocyanate of claim 10 wherein the sterically hindered phenol comprises 2,6-di-tert-butyl-4-methylphenol.

13. The blocked polyisocyanate of claim 9 wherein at least 95 of the NCO groups have been blocked with a sterically hindered phenol.

14. The blocked polyisocyanate of claim 10 wherein at least 95 of the NCO groups have been blocked with a sterically hindered phenol.

15. The blocked polyisocyanate of claim 11 wherein at least 95 of the NCO groups have been blocked with a sterically hindered phenol.

16. The blocked polyisocyanate of claim 12 wherein at least 95 of the NCO groups have been blocked with a sterically hindered phenol.

17. A one-component coating, adhesive or sealant composition containing the blocked polyisocyanates of claim 9.

18. The one component composition of claim 17 wherein the coating, adhesive or sealant is approved for contact with foods and/or drinking water under FDA 175.105 and 175.300.

19. A substrate coated with the one-coating coating composition of claim 9.
